(19) United States
(12) Patent Application Publication
(10) Pub. No.: US 2024/0293855 A1
(43) Pub. Date: Sep. 5, 2024

(54) A Low Roughness Lithium Metal Anode Produced Via Multiple Compressions

(71) Applicant: Soelect Inc., Greensboro, NC (US)

(72) Inventor: Sungjin Cho, Summerfield, NC (US)

(21) Appl. No.: 18/578,374

(22) PCT Filed: Mar. 7, 2023
(86) PCT No.: PCT/US2023/014721

§ 371 Date: Jan. 11, 2024

Related U.S. Application Data
(60) Provisional application No. 63/317,345, filed on Mar. 7, 2022.

(51) Int. Cl. B21B 3/00; B21B 13/02; H01M 4/02; H01M 4/04; H01M 4/1395; H01M 10/0525; H01M 12/04; H01M 12/08

(52) U.S. Cl. CPC B21B 3/00; B21B 13/02; H01M 4/0435; H01M 4/1395; H01M 10/0525; H01M 12/04; H01M 12/08; H01M 2004/027

(57) ABSTRACT

A process that includes compressing a lithium metal material having an initial material thickness and initial material surface roughness into a compressed lithium metal material having a first compressed material thickness is disclosed. The method further includes compressing the compressed lithium metal material one or more additional times into a further compressed lithium metal material having a final compressed material thickness and a final material surface roughness, wherein the final compressed material thickness having a value at or between 5 micrometers and 200 micrometers and is less than the initial compressed material thickness and wherein the final material surface roughness is smoother than the initial material surface roughness and is characterized by Ra value of less than or equal to 1.0 micrometers and a Rz value of less than or equal to 5.0 micrometers.

### CROSS REFERENCE TO RELATED APPLICATIONS

This application claims benefit of U.S. Provisional Application Ser. No. 63/317,345 filed on Mar. 7, 2022, the disclosure of which is incorporated herein by reference in its entirety.

### TECHNICAL FIELD

The subject matter described herein relates to lithium metal material processing in the manufacture of lithium metal anodes. More specifically, the subject matter relates a low roughness lithium metal anode produced via multiple compressions.

### BACKGROUND

The use of lithium metal as an electrode material in battery manufacturing is hindered by the process of a single compression rolling system and native surface film provided by manufacturers. This results in detrimental effects on the battery's cycling behavior and overall performance, due to the influence of surface roughness and available area of excessive grain boundaries, both of which aid in dendrite formation. Dendrite growth is known to thrive on rough surface areas and lithium grain boundaries, making it imperative to take measures to reduce the impact of surface roughness on the growth behavior of lithium dendrites during charging. Notably, the formation of dendrites removes accessible lithium from the cell, leading to a decrease in the long-term performance and lifetime of the battery. Accordingly, there is a need for an efficient lithium metal manufacturing process that can reduce dendrite formation.

### SUMMARY

The disclosed subject matter includes a method for producing a low roughness lithium metal anode via multiple compressions. In some embodiments, the method includes compressing, by a first rolling mill unit, a lithium metal material having an initial material thickness and initial material surface roughness into a compressed lithium metal material having a first compressed material thickness, wherein the first compressed material thickness is less than the initial material thickness. The method further includes compressing, by the first rolling mill unit or at least a second rolling mill unit, the compressed lithium metal material one or more additional times into a further compressed lithium metal material having a final compressed material thickness and a final material surface roughness, wherein the final compressed material thickness having a value at or between 5 micrometers and 200 micrometers and is less than the initial compressed material thickness and wherein the final material surface roughness is smoother than the initial material surface roughness and is characterized by an average roughness (Ra) value of less than or equal to 1.0 micrometers and a maximum roughness (Rz) value of less than or equal to 5.0 micrometers

Another embodiment of the disclosed subject matter includes a method wherein the lithium metal material is repeatedly introduced to the first rolling mill unit in a one-way mechanical direction via multiple passes.

Another embodiment of the disclosed subject matter includes a method wherein the lithium metal material is introduced to the first rolling mill unit and the at least second rolling mill unit of the rolling mill system in a single mechanical direction via a single pass.

Another embodiment of the disclosed subject matter includes a method wherein the lithium metal material is introduced to the rolling mill system without folding the lithium metal material and/or without introducing the lithium material in a bi-directional manner.

Another embodiment of the disclosed subject matter includes a method wherein the average roughness value and maximum roughness value exhibited by the further compressed lithium metal material are both reduced by each compression performed by the first rolling mill unit and/or the second rolling mill unit.

Another embodiment of the disclosed subject matter includes a method wherein the first rolling mill unit and/or the second rolling mill unit is a tandem rolling mill device.

Another embodiment of the disclosed subject matter includes a method wherein the lithium metal material is a lithium metal workpiece and/or at least a portion of lithium metal foil.

Another embodiment of the disclosed subject matter includes a method wherein the further compressed lithium metal material exhibits a reduction in the number of grains, as compared to the lithium metal material and compressed lithium metal material, after being compressed by one or more of the first rolling mill unit and the second rolling mill unit.

Another embodiment of the disclosed subject matter includes a method wherein the first rolling mill unit and the second rolling mill unit are positioned in series and configured with incrementally decreasing rolling gap sizes such that the lithium metal material is incrementally compressed by the rolling mill system.

Another embodiment of the disclosed subject matter includes a method wherein the compression rate applied to the lithium metal material is controlled by incrementally decreasing the rolling gap spaces associated with working roller components of the first rolling mill unit and/or the second rolling mill unit.

Another embodiment of the disclosed subject matter includes a method wherein a rolling gap space formed by the positioning of an upper roller component and a lower working roller component of the first rolling mill unit and/or the at least second rolling mill unit is adjusted to incrementally control the compression rate applied to the lithium metal material.

Another embodiment of the disclosed subject matter includes a method wherein the further compressed lithium metal material is used to manufacture a lithium metal anode.

Another embodiment of the disclosed subject matter includes a method wherein the lithium metal anode is compatible with a lithium-ion battery, a lithium sulfur battery, a lithium air battery, or a solid-state battery.

In another embodiment, the disclosed subject matter includes a method for controlling the compression rate applied to lithium metal material including the introducing of a lithium metal material having an initial material thickness and initial material surface roughness into a first rolling mill unit of a rolling mill system and compressing, by the first rolling mill unit, the lithium metal material into a compressed lithium metal material having a first compressed material thickness and first compressed material surface roughness. The method further includes introducing the compressed lithium metal material into either i) the first rolling mill again or ii) at least a second rolling mill unit of the rolling mill system that is positioned in series with the first rolling mill unit. The method also includes compressing, by the first rolling mill unit or the at least second rolling mill unit, the compressed lithium metal material one or more additional times into a further compressed lithium metal material having a final compressed material thickness and a final material surface roughness, wherein the final compressed material thickness having a value at or between 5 micrometers and 200 micrometers and is less than the initial compressed material thickness and wherein the final material surface roughness is smoother than the initial material surface roughness and is characterized by an average roughness (Ra) value of less than or equal to 1.0 micrometers and a maximum roughness (Rz) value of less than or equal to 5.0 micrometers

### BRIEF DESCRIPTION OF THE DRAWINGS

Embodiments of the subject matter described herein will now be explained with reference to the accompanying drawings, wherein like reference numerals represent like parts, of which:

FIG. 1 is an exemplary rolling mill system including a single rolling mill unit according to an embodiment of the subject matter described herein;

FIG. 2 is a block diagram illustrating the functionality of a single rolling mill unit of a rolling mill system according to an embodiment of the subject matter described herein;

FIG. 3 is a block diagram of an exemplary rolling mill system including a plurality of rolling mill units according to an embodiment of the subject matter described herein;

FIG. 4 illustrates the surface roughness exhibited by lithium metal after two compressions according to an embodiment of the subject matter described herein;

FIG. 5 illustrates the surface roughness exhibited by lithium metal after a series of compressions according to an embodiment of the subject matter described herein;

FIG. 6 is a graph illustrating cell formation data for two compressions and ten compressions according to an embodiment of the subject matter described herein;

FIG. 7 depicts graphs illustrating cell rate data for two compressions and ten compressions according to an embodiment of the subject matter described herein;

FIG. 8 depicts graphs illustrating cycle test data for two compressions and ten compressions according to an embodiment of the subject matter described herein;

FIG. 9 is a flow chart depicting an exemplary method for producing a low roughness lithium metal anode via multiple compressions according to an embodiment of the subject matter described herein; and

FIG. 10 is a flow chart depicting an exemplary method for controlling the compression rate applied to lithium metal material according to an embodiment of the subject matter described herein.

### DETAILED DESCRIPTION

The subject matter described herein discloses methods and systems for controlling the compression rate applied to lithium metal material. In some embodiments, the disclosed subject matter includes a calendaring and/or rolling process that is utilized for preparing lithium metal foils with less thickness and less surface roughness. The disclosed subject matter provides a commercially viable manufacturing system able to produce lithium metal sheets by controlling compression rates. For example, the disclosed system enables a simple, fast, and reproducible technique to flatten, thin, and elongate lithium metal material (e.g., a lithium metal foil). In some embodiments, a small-scale lithium metal electronic rolling mill may be used to compress lithium metal foils to 50 micrometers (μm). Further, High Dynamic range 3D scanning can be performed using a Keyence 3D Optical Profilometer (VR-6000 Series) to compare and/or show changes in the lithium metal surface roughness and the number of grains after processing. Life cycle performance of reference LiX-50 μm anodes can be evaluated, while data regarding the specific life cycle performance of the anodes may be collected and analyzed. Notably, data pertaining to the capacity, efficiency, and stability of the lithium metal anodes over a specified number of charge-discharge cycles can be examined. While the technique(s) depicted herein are described with relation to small scale production, it is understood to those of ordinary skill in the art that larger scale multi-roll systems can be configured with the same methodology without departing from the scope of the disclosed subject matter.

Different rates of compression were tested on lithium metal material samples with the same final target thickness to observe the difference in physical properties (e.g., thickness and roughness) and electrochemical performance (e.g., capacity, efficiency, and lifetime) associated with the two lithium metal material end products. For example, the rolling process was conducted through use of a two-high rolling mill. Lithium metal foil was introduced into the rolling mill system and passed through sequentially and in series at different compression gaps (i.e., different rolling mill units with decreasing sizes of rolling gap spaces) until reaching the target thickness and roughness. Notably, surface roughness of the compressed lithium metal foils was evaluated using three dimensional (3D) optical profilometry, measuring roughness values, and generating high magnification surface images. The compressed lithium metal foil material was ultimately used as the anode in battery cells to evaluate several electrochemical performance metrics. In some embodiments, the lithium metal anode(s) produced by the compressed lithium metal foil material is compatible with a lithium-ion battery, a lithium sulfur battery, a lithium air battery, or a solid-state battery.

### Rolling System Mechanical Description

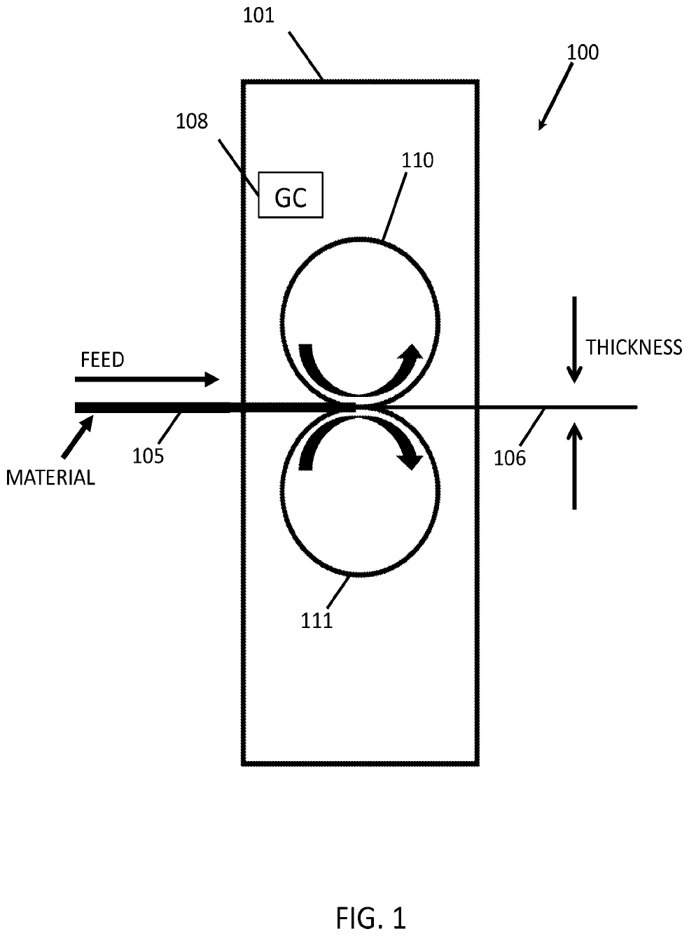

Rolling mill systems are essential machines in the metalworking industry. Rolling mills are utilized to reduce the thickness of metal sheets and to produce uniform cross-sectional shapes. FIG. 1 illustrates an example rolling mill system 100 that includes a single rolling mill unit 101 according to an embodiment of the subject matter described herein. In particular, rolling mill unit 101 includes at least two roller components, i.e., an upper roller component 110 and a lower working roller component 111. Notably, upper roller component 110 and a lower working roller component 111 are positioned apart such that a small gap or space exists between the two roller components. The distance of small rolling gap between the roller components may be configured to receive and compress lithium metal material (e.g., lithium metal foil) of a thickness larger than the rolling gap, such that the exiting compressed lithium metal material exhibits a thickness equal to the rolling gap. Rolling mill unit 101 may also include a rolling gap controller 108 that can be used by an operator to adjust the roller components such that the rolling gap distance can be controlled (as described below).

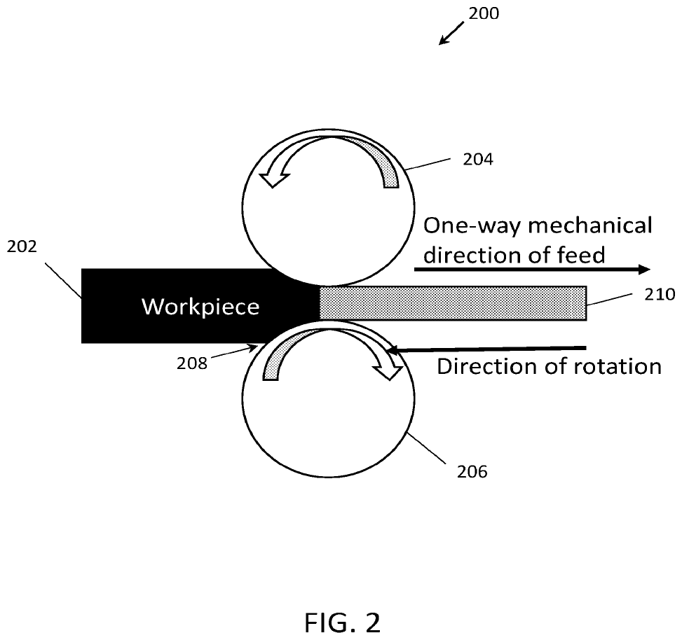

As a further example, FIG. 2 depicts an exemplary rolling mill unit 200 (i.e., not unlike rolling mill unit 101 in FIG. 1) that includes an upper roller component 204 and a lower working roller component 206. Notably, upper roller component 204 may be configured to rotate in a counter-clockwise direction and lower working roller component 206 may be configured to rotate in an opposite clockwise direction. By configuring the roller components to rotate in this matter, rolling mill unit 200 is configured to receive an introduced lithium metal material workpiece 202. Specifically, lithium metal material workpiece 202 may be fed into a rolling gap 208 formed by the space existing between upper roller component 204 and lower working roller component 206. After the lithium metal material workpiece 202 is fed between the two rollers, the material is compressed and flattened as it passes through the gap 208 existing between the rollers. Once processed by the roller components of rolling mill unit 200, a compressed lithium metal material 210 is produced. In particular, the surface roughness of the lithium metal material is greatly reduced using the gradual/incremental compression control methodology described herein.

Returning to FIG. 1, lithium metal material 105 is inserted into rolling mill unit 101, whose roller components have been positioned to present a particular gap space (e.g., 80 μm). After receiving the lithium metal material 105, rolling mill unit 101 compressed the material to form a compressed lithium metal material 106. Notably, the thickness of the compressed lithium metal material 106 is equal to the gap space (e.g., 80 μm) between the roller components 110-111 After the compressed lithium metal material 106 completely exits the rolling mill unit 101, the material may be reinserted into rolling mill unit 101 again. However, the gap space may be incrementally adjusted and/or reduced to a smaller gap size (e.g., 70 μm) for further processing. Notably, the rolling gap space and the lithium metal material thickness can be compressed to any thickness ranging between 5 μm and 200 μm. By gradually reducing the gap size in this manner (and further repeating if necessary), the compression rate of the lithium metal material can be controlled. As discussed herein, controlling the compression that is applied to lithium metal material will reduce the creation of additional grain boundaries, thereby preventing dendrite growth and improving the performance of an associated lithium metal anode. Further, by gradually compressing the lithium metal material in this manner, the surface roughness of the lithium material is also incrementally reduced. Specifically, the incremental compression rolls allow for the average roughness (Ra) value of the lithium metal material to attain a measurement of less than or equal to 1.0 μm, and the maximum roughness (Rz) value of the lithium metal material to attain a measurement of less than or equal to 5.0 μm.

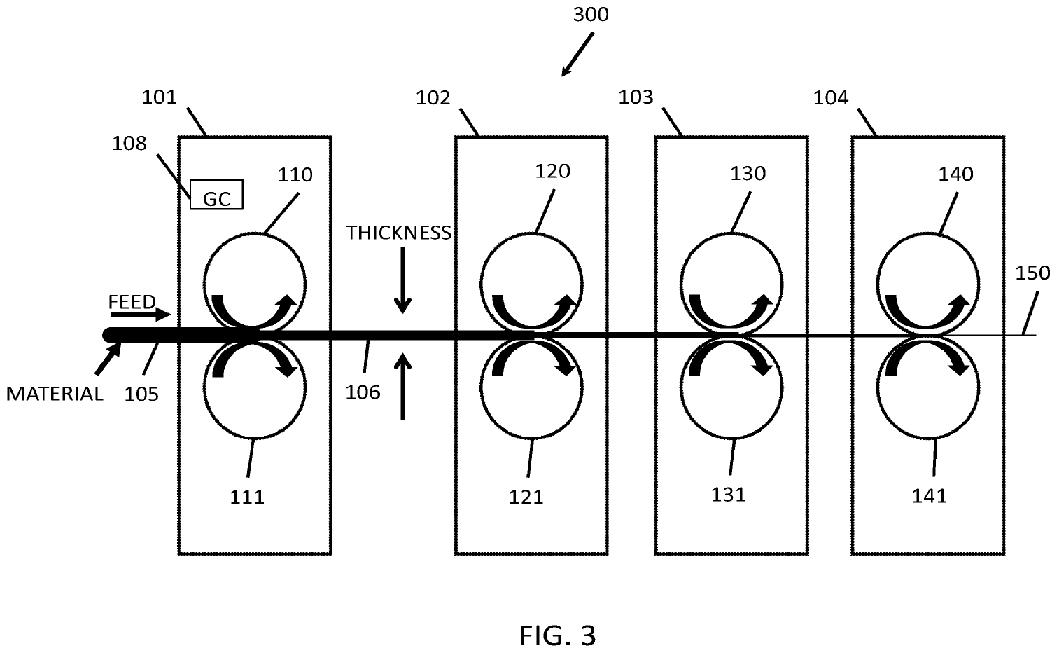

FIG. 3 illustrates an example rolling mill system 300 that includes a plurality of rolling mill units according to an embodiment of the subject matter described herein. Although FIG. 3 illustrates four (4) rolling mill units 101-104, any number of rolling mill units may be utilized in a rolling mill system without departing from the scope of the disclosed subject matter. Notably, each of the rolling mill units 101-104 has a smaller rolling gap than the previous rolling mill unit, i.e., rolling mill unit 101 has the largest rolling gap and rolling mill unit 104 has the smallest rolling gap (as discussed further below).

As described above with respect to FIG. 1, rolling mill unit 101 comprises a two-high rolling mill that includes two horizontal roller components, i.e., upper working roller component 110 and lower working roller component 111. Similarly, rolling mill unit 102 includes upper working roller component 120 and lower working roller component 121, rolling mill unit 103 includes upper working roller component 130 and lower working roller component 131, and rolling mill unit 104 includes upper working roller component 140 and lower working roller component 141.

In some embodiments, a lithium metal material 105 (e.g., lithium metal foil and/or workpiece) is introduced into rolling mill unit 101 of the rolling mill system 100. For example, lithium metal material 105 is fed into a rolling gap that is formed by the spacing distance between upper working roller component 110 and lower working roller component 111 of rolling mill unit 101 (e.g., a tandem rolling mill unit). Notably, the rolling mill system and/or rolling mill unit 101 may be configured with a gap controller 108, which may include a screw down controlling mechanism by which an operator can utilize to adjust the spacing distance between the two roller components, thereby controlling the thickness of the lithium metal material after rolling. Although not depicted in FIG. 3, each of rolling mill units 102-104 may also be equipped with a gap controller. In some embodiments, the lithium metal material 105 has an initial thickness of 100 μm and is introduced into an 80 μm rolling gap associated with rolling mill unit 101. While traversing through the rolling gap formed by upper working roller component 110 and lower working roller component 111, the lithium metal material 105 is compressed into a compressed lithium metal material 106. Notably, compressed lithium metal material 106 after rolling will exhibit a thickness corresponding to the rolling gap (e.g., 80 μm) of rolling mill unit 101. By gradually reducing the thickness of the lithium metal material in this manner (e.g., 100 μm to 50 μm via intermediate compression steps vs. a single 100 μm to 50 μm compression step as is commonly practiced), the creation of additional grain boundaries in the microstructure of the lithium metal material can be significantly reduced or eliminated.

Returning to FIG. 1, compressed lithium metal 106 may then be subsequently introduced into a 70 μm rolling gap associated with rolling mill unit 102. Similarly, the further compressed lithium metal material (with reduced thickness) may subsequently be introduced to rolling mill units 103-104, each of which has a smaller rolling gap than the previous rolling mill unit (e.g., rolling mill unit 103 may have a rolling gap of 60 μm and rolling mill unit 104 may have a rolling gap of 50 μm). Notably, any number of in-line rolling mill units can be used and the associated rolling gaps may be configured in any manner to properly process the lithium metal material (i.e., reduce material surface roughness, reduce creation of grain boundaries, etc.) at any desired final thickness. Further, depending on the number of rolling mill units are being deployed in rolling mill system 100, the lithium metal material may be processed to the desired final thickness without any need for winding and re-insertion into the rolling mill system 100. In FIG. 1, after the compressed lithium metal material is processed by the rolling mill units 101-104 of rolling mill system 100, a final compressed lithium metal material 150 with the desired final thickness (e.g., 50 μm) is produced.

The impact of the two-high rolling mill on a thin lithium metal material is significant. For example, as the lithium metal material passes through the roller components, the material experiences both compressive and tensile forces. The compressive force is applied by the roller components and is responsible for reducing the thickness of the material. The tensile force is applied by the stretching of the lithium metal material as it passes through the roller components. The combination of the compressive and tensile forces results in the elongation of the material in the rolling direction (i.e., a single or one-way mechanical direction). By putting the lithium metal material through sequential rolling processes via a plurality of in-series rolling mill units, the lithium foil thickness can be reduced while minimizing damage (i.e., reducing the creation of grain boundaries at the microstructure level of the material) and reducing the material surface roughness. Each of these benefits notably enhance the performance of an anode component made from the processed lithium metal material.

For example, by increasing the rate of compression of the lithium metal material, the reduction of both the material surface roughness and the number of grains can be improved such that dendrite growth is limited, thereby improving battery performance. This is demonstrated by comparing the surface structure and life cycle performance of lithium metal anode material that has been processed using the techniques described herein to produce a reference 50 μm anode material (e.g., reference LiX-50 μm anode material) with conventionally processed 50 μm anode material. Notably, the disclosed LiX-50 μm anode material is prepared with varying degrees of calendaring/rolling (as described above) to reduce the material thickness to 50 μm. Starting thicknesses of 100 μm bare lithium foil were used, and two levels of calendaring were evaluated: low and high.

While lithium metal anode manufacturers typically use a single roll for compressing lithium metal to a target thickness, the disclosed subject matter is configured to produce the target thickness at using gradual and/or incremental compression steps that are expected to result in a smoother material surface and the reduction in the number of grains in the lithium metal material. As used herein, the terms ‘smoother’ or ‘less rough’ refers to the reduction of the average roughness value and/or the maximum roughness value of a material surface. In one example, the surface of a compressed lithium metal material exhibiting an average roughness value of 0.9 μm would be smoother or less rough than the surface of a material exhibiting an average roughness value of 3.0 μm. As dendrites tend to form along lithium metal grain boundaries, reduction of these grains within the lithium metal material will limit the surface area availability for dendrite growth. The following disclosure supports the expectations of lower surface roughness, reduced height range between the lithium metal structure's maximum and minimum height, and reduced number of grains within the material.

### Experiment

The objective of the following experiment was to compare the surface structure and life cycle performance of 50 μm anodes that were prepared using varying degrees of calendaring and rolling. The experiment was conducted using two samples of bare lithium foil, each with an initial thickness of 100 μm. Notably, two levels of calendaring were evaluated: low and high. The following materials were used in this experiment: 0.1×100 mm lithium metal foil, lithium metal electronic rolling mill, Celgard 2320 (width 145 millimeters (mm)), micrometer, Keyence 3D optical profilometer (VR-6000 Series), and Neware Battery Cycler Technology.

### Preparation of Roll-Pressed Lithium-Metal Anodes

Notably, an electronic lithium metal rolling mill can be utilized to compress each lithium metal sample. In one process, the lithium metal foil anode was compressed using a 1:1 compression ratio (approximately 10 μm reduction of material thickness : approximately 10 μm reduction of roller gap), resulting in 50 compressions to reach a goal thickness of 50 μm. A starting gap of 150 μm was used, and the gap was determined by considering the initial thickness of Celgard 2320 material (40 μm) and lithium metal foil (100 μm), with a 10 μm increase to initiate gradual compressions of the material.

This technique allowed for a more gradual reduction, which allows for the formation of a smoother material surface and reduction in the number of lithium metal grains. Notably, the compressed lithium metal material may be subjected to repeated compression rolls, each of which incrementally reduces the average roughness value and the maximum roughness value associated with the surface of the material.

The foil was introduced and/or fed through the rolling mill system in the same direction (i.e., a one-way mechanical direction) to ensure the compression of the lithium metal sample occurred in one single direction (e.g., not folded or introduced in a bi-directional manner). For example, a single sheet of Celgard 2320 was used per 15 μm reduction to protect the lithium metal foil during set of compressions. The lithium metal material thickness was measured after each compression, and no surface damage was observed after the compression trial was completed.

Compression parameters were then adjusted for a second process, instead using a 1:3.33 compression ratio (approx. 3-4 μm reduction of material thickness : 15 μm reduction of compression gap), resulting in 15 compressions to attain a final material thickness of 50 μm. A starting gap of 140 μm was used to allow for quicker, yet controlled reduction of the material thickness. A 10 μm reduction in the compression gap was performed every 2 rolls until 60 μm of material thickness was observed. Afterwards, a 90 μm compression gap was used to complete the final thickness reduction within 5 compressions, resulting in a 50 μm material thickness after 15 total compressions. A single sheet of Celgard 2320 material was changed after each compression to reduce surface damage to the material, and minimum surface damage was observed after the compression trial was completed.

### 3-D Optical Profilometry

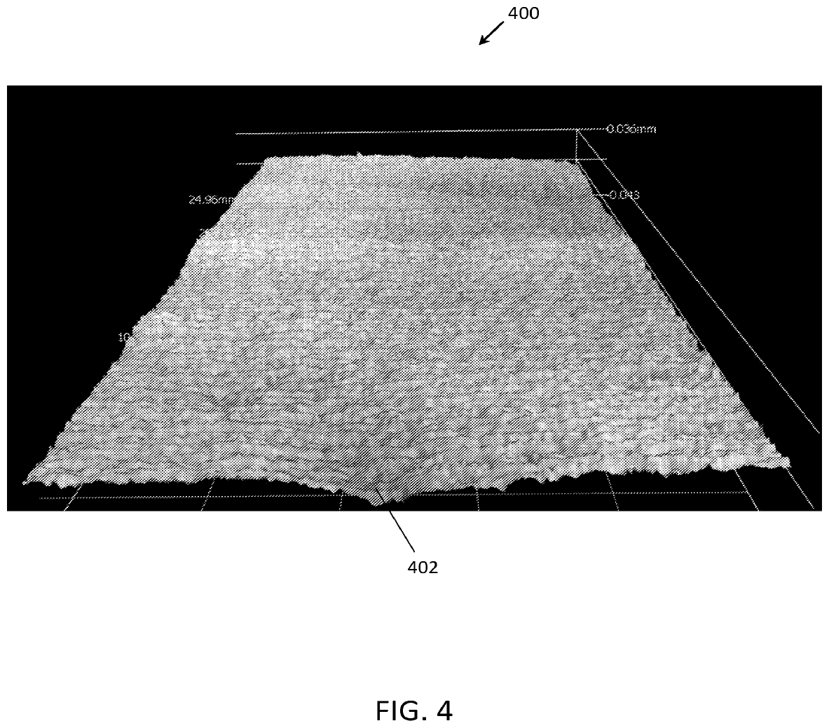

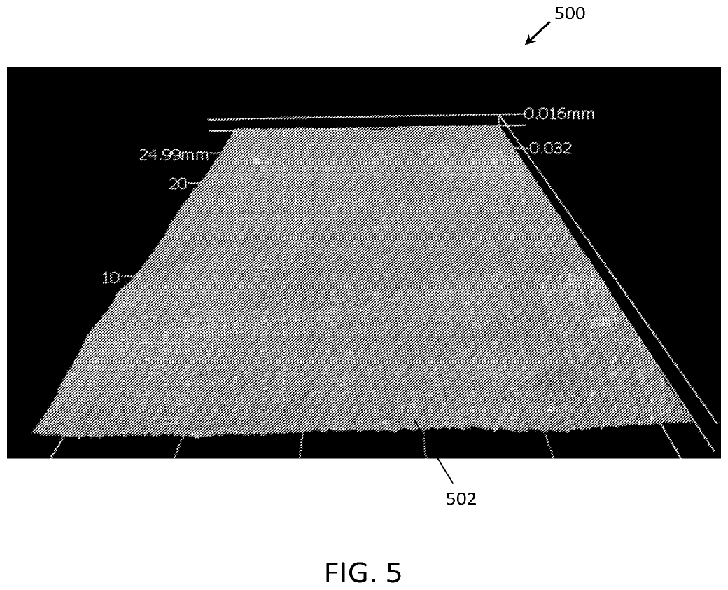

The Keyence 3-D Optical Profilometer was utilized to identify the comparison of 50 μm lithium metal foil received directly from a manufacturing facility (via 1 roll/compression) versus post-milled 50 μm lithium metal foil prepared with multiple rolls in the manner disclosed herein. Cross-section 3D optical measurements were carried out at a high resolution, high magnification camera, and 40× magnification. Surface roughness profiles of each sample were measured, resulting in total average surface roughness (Ra, μm) of each sample along with the max-min height differences (Rz, μm). Samples were analyzed in a dry-room environment under <1.0 parts per million (ppm) of relative humidity (RH) at −70° C. dew point. The results of the roughness measurements of the two samples are indicated below in Table 1. Comparing the two processes, the overall roughness decreased with multiple compression rolls. The average roughness (Ra) decreased by a factor of 5, while the maximum roughness depth (Rz) decreased by a factor of 4. The magnified optical surface images shown in FIGS. 4 and 5 clearly show the transformation to a flatter, less textured surface. Specifically, FIG. 4 illustrates an image 400 of a 3D optical measurement of a lithium metal foil material 402 that is associated with a sample that has only been rolled 1-2 times. In contrast, FIG. 5 illustrates an image 500 of a 3D optical measurement of a lithium metal foil material 502 that is associated with a sample that has been rolled multiple times (e.g., 10 times). As indicated in Table 1 below, the average roughness Ra value was significantly reduced (e.g., 0.577 μm vs. 2.86 μm) when multiple (e.g., 10) compression rolls were performed on the lithium metal material. Similarly, the maximum roughness Rz value was also significantly reduced (e.g., 4.86 μm vs. 19.29 μm) when multiple compression rolls were conducted instead of 1-2 compression rolls.

TABLE 1
Roughness measurement values for lithium metal
foil at different compression conditions

| | 1-2 rolls | Multiple rolls |
|---|---|---|
| Ra | 2.86 μm | 0.577 μm |
| Rz | 19.29 μm | 4.86 μm |

### Formation Cycling

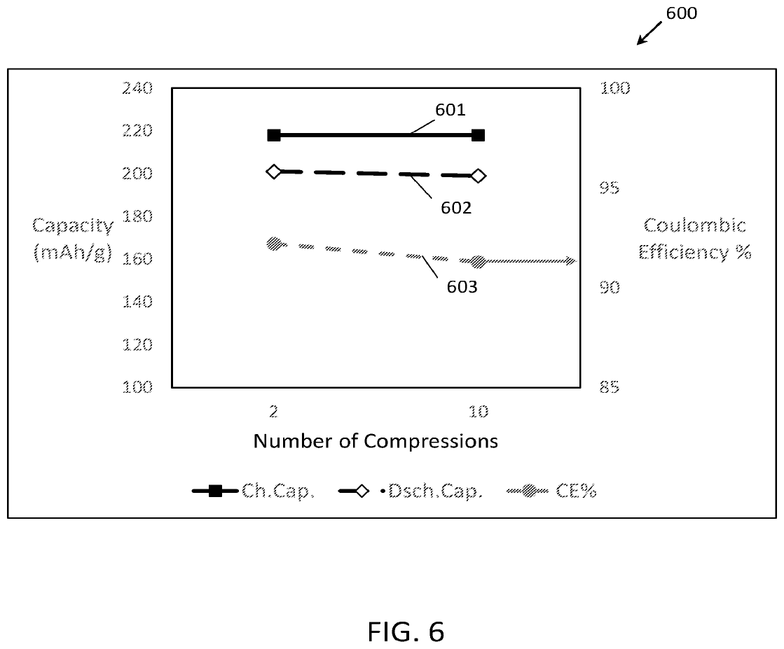

Coin cells were prepared from the lithium foil (e.g., lithium metal material) processed under the different compression conditions (i.e., 2 passes vs. 10 passes) through the rolling mill unit to reach a thickness of 50 μm. All of the cells used NMC811 as a cathode element. Two cells were prepared for each sample (i.e., a first sample of lithium metal material that has been rolled 2 times was used to produce two (2) coin cells and a second sample of lithium metal material that has been rolled 10 times was used to produce two coin cells), using the same cathode and electrolyte configuration. The formation cycles of the cells were run at a 0.1 C rate for charge and discharge in an electrochemical window of 3.0 volts (V) to 4.3 volts. The average cell data for these samples is presented in FIG. 6 as well as Table 2 below. For example, plot 600 in FIG. 6 illustrates a graph that includes a charging capacity plot line 601, a discharging capacity 602, and a Coulombic efficiency (CE) plot line 603. Notably, there was only a slight difference between the discharge capacity values of the samples, while the charge capacity values were exactly the same. For example, the sample processed through 10 compressions exhibited a slightly lower capacity than the two-time compression sample (e.g., see plot line 602). Both samples demonstrated similar coulombic efficiency of acceptable quality above 90%.

TABLE 2
Cell formation data for 2 and 10 roll compressions

| | Charge | Discharge | Coulombic |
|---|---|---|---|
| Number of | Capacity | Capacity | Efficiency |
| Compressions | (mAh) | (mAh) | (%) |
| 2 | 218 | 201 | 92.2 |
| 10 | 218 | 199 | 91.3 |

### Rate Test

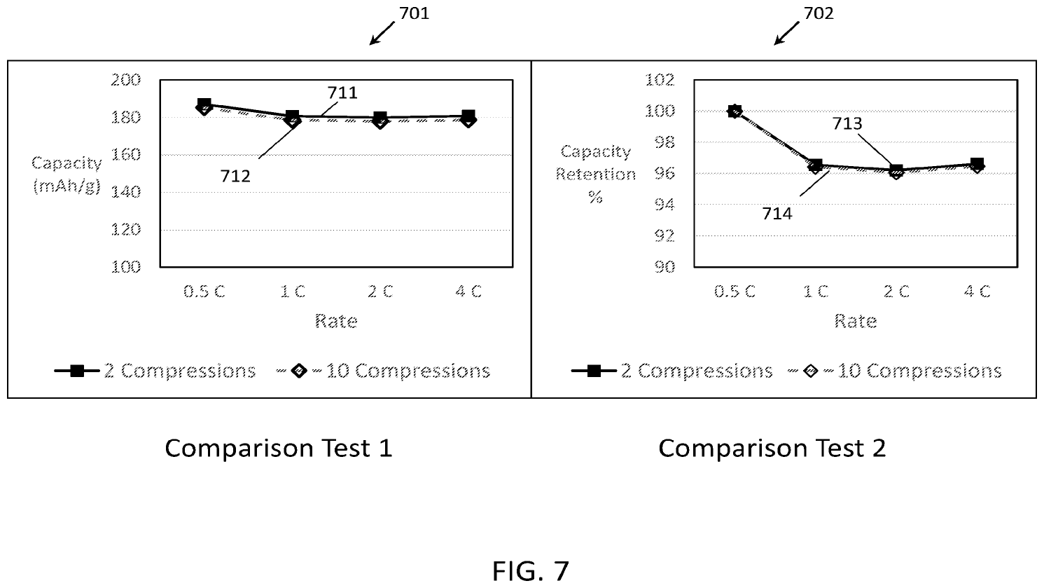

Following the cell formation cycle, rate tests of the cells were run at 0.5 C, 1 C, 2 C, and 4 C charging rates, with the cell data presented in Table 3 below as well as plots 701-702 of FIG. 7. The measured capacities of the two samples were very similar under these charging rate conditions. For example, the 2-compression plot line 711 in plot 701 (i.e., comparison test no. 1) is largely identical to the 10-compression plot line 712 in plot 701. Similarly, the 2-compression plot line 713 in plot 702 (i.e., comparison test no. 2) is largely identical to the 10-compression plot line 714 in plot 702. Both samples retained above 96% of their initial capacity when charging at higher rates, thus showing satisfactory performance. While there is a small drop in capacity occurs above a 0.5 C charging rate, there is no additional reduction in capacity when increasing the charging rate from 1 C to either the 2 C rate or the 4 C rate. This demonstrates that the various compression processes do not result in damage to the lithium metal foil and/or cause a change in cell performance. The fact that there is no significant difference in the performance between the two samples from the different compression processes is a strong indicator that the same result can be achieved in fewer steps.

TABLE 3
Cell rate data for 2 and 10 roll compressions

| Number of | Discharge Capacity at Different Rates (mAh/g) | | | |
|---|---|---|---|---|
| Compressions | 0.5 C | 1 C | 2 C | 4 C |
| 2 | 187.1 | 180.6 | 180.0 | 180.8 |
| | (100%) | (96.56%) | (96.20%) | (96.62%) |
| 10 | 185.1 | 178.5 | 177.9 | 178.6 |
| | (100%) | (96.43%) | (96.07%) | (96.46%) |

### Cycle Tests

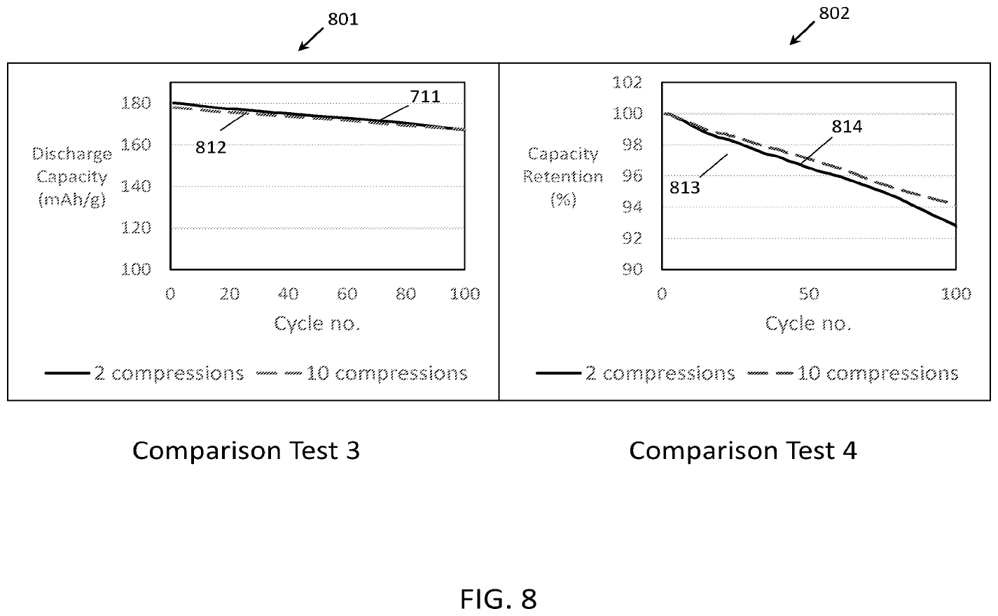

The test cells were cycled at 4 C charge and 1 C discharge to evaluate cycle lifetime performance and capacity retention under fast charging conditions. The data is shown in table 4 below and in FIG. 8. Both anodes demonstrated over 92% retention of initial capacity after 100 cycles. The high retention for each process after 100 cycles indicates there was no significant damage to the anodes as a result of compression. Notably, the two samples performed in a similar manner for the first 81 cycles (e.g., see plot lines 811 and 812 in plot 801 of FIG. 8), with less than 0.5% difference between the respective capacity retention values (e.g., see plots 813-814 in plot 802 of FIG. 8). After cycle no. 81, the cell with the anode material compressed twice began losing capacity at a slightly higher rate. By cycle no. 100, the difference in retention reached 1.3%, which is still fairly low. The data presented by plots 801-802 in FIG. 8 demonstrates that the two compression processes produce consistent results. This growing difference in capacity retention demonstrates the effect of the additional compression rolls on decreasing surface roughness and improving battery performance.

TABLE 4
Cycle lifetime data for 2 and 10 roll compressions

| | Cycle 1 | Cycle 100 | Capacity |
|---|---|---|---|
| Number of | Capacity | Capacity | Retention |
| Compressions | (mAh/g) | (mAh/g) | (%) |
| 2 | 180.1 | 167.2 | 92.8 |
| 10 | 177.8 | 167.4 | 94.1 |

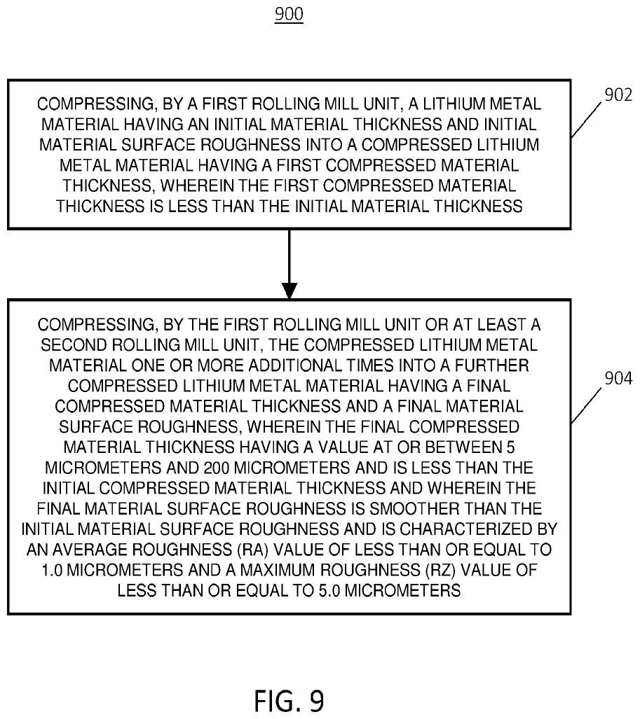

FIG. 9 is a flow chart depicting an exemplary method 900 for compressing lithium metal material according to an embodiment of the subject matter described herein. In block 902, method 900 includes compressing, by a first rolling mill unit, a lithium metal material having an initial material thickness and initial material surface roughness into a compressed lithium metal material. Notably, the resulting compressed lithium metal material is characterized as having a first compressed material thickness, wherein the first compressed material thickness is less than the initial material thickness. The compressed lithium metal material also has a first compressed material surface roughness that is smoother as compared to the initial material surface roughness.

In block 904, method 900 includes compressing, by the first rolling mill unit or at least a second rolling mill unit, the compressed lithium metal material one or more additional times into a further compressed lithium metal material having a final compressed material thickness and a final material surface roughness. In some embodiments, the further compressed lithium metal material is subjected to repeated compression rolls, each of which incrementally reduces the average roughness value and the maximum roughness value associated with the surface of the material. Notably, the final compressed material thickness includes and ranges between 5 micrometers and 200 micrometers and is less than the initial compressed material thickness. Likewise, the final material surface roughness is smoother than the initial material surface roughness and is characterized by an average roughness (Ra) value of less than or equal to 1.0 micrometers and a maximum roughness (Rz) value of less than or equal to 5.0 micrometers.

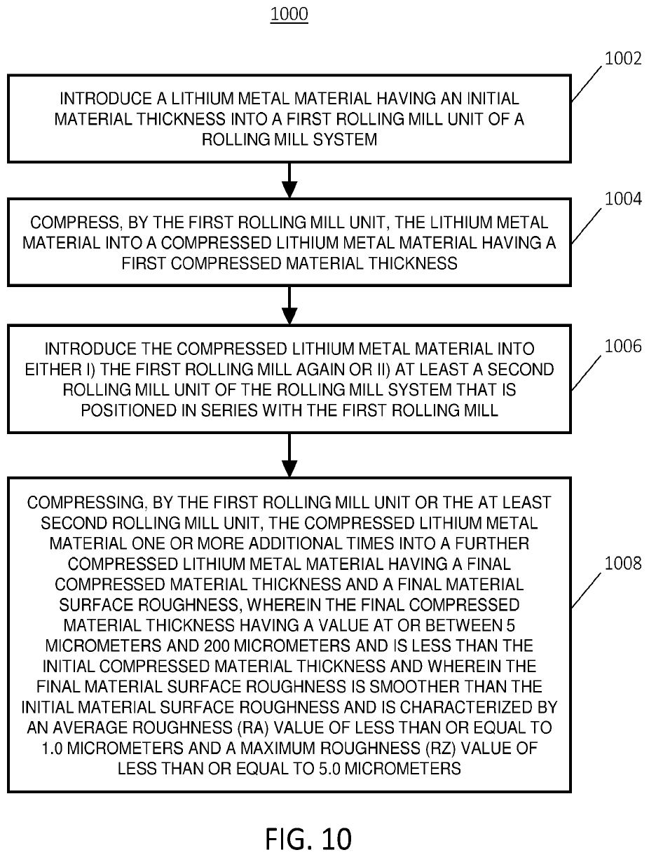

FIG. 10 is a flow chart depicting an exemplary method 1000 for controlling the compression rate of lithium metal material according to an embodiment of the subject matter described herein. In block 1002, method 1000 includes introducing a lithium metal material having an initial material thickness into a first rolling mill unit of a rolling mill system. In some embodiments, a lithium metal foil workpiece is fed into a first rolling mill unit of a rolling mill system that comprises a plurality of rolling mill units. Notably, the gap space existing between the two working rollers of the first rolling mill unit is set in such a manner that the workpiece will not be immediately compressed to s significant degree.

In block 1004, method 1000 includes compressing, by the first rolling mill unit, the lithium metal material into a compressed lithium metal material having a first compressed material thickness. In some embodiments, after the lithium metal material/workpiece is introduced to the rolling mill unit, the material is compressed by the two working rollers rotating in opposite directions.

In block 1006, method 1000 includes compressing, by introducing the compressed lithium metal material into either i) the first rolling mill unit or ii) at least a second rolling mill unit of the rolling mill system that is positioned in series with the first rolling mill unit. In some embodiments, the lithium metal material compressed by the first rolling mill unit is subsequently fed again into the first rolling mill unit (e.g., in a repeatable manner). In other embodiments, the lithium metal material compressed by the first rolling mill unit is fed directly into a second rolling milling unit of the rolling mill system. Notably, the first rolling mill unit and the second rolling mill unit are placed in-line and in series in order to incrementally reduce the thickness of compressed lithium metal material.

In block 1008, method 1000 includes compressing the compressed lithium metal material into a further compressed lithium metal material. In some embodiments, the first rolling mill unit or the at least second rolling mill unit, compresses the compressed lithium metal material one or more additional times into a further compressed lithium metal material that has a final compressed material thickness and a final material surface roughness, wherein the final compressed material thickness has a value at or between 5 micrometers and 200 micrometers and is less than the initial compressed material thickness. Further, the final material surface roughness is smoother than the initial material surface roughness and is characterized by an average roughness (Ra) value of less than or equal to 1.0 micrometers and a maximum roughness (Rz) value of less than or equal to 5.0 micrometers.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for producing a low roughness lithium metal material anode via multiple compressions comprising:
compressing, by a first rolling mill unit, a lithium metal material having an initial material thickness and initial material surface roughness into a compressed lithium metal material having a first compressed material thickness, wherein the first compressed material thickness is less than the initial material thickness; and
compressing, by the first rolling mill unit or at least a second rolling mill unit, the compressed lithium metal material one or more additional times into a further compressed lithium metal material having a final compressed material thickness and a final material surface roughness, wherein the final compressed material thickness having a value at or between 5 micrometers and 200 micrometers and is less than the initial compressed material thickness and wherein the final material surface roughness is smoother than the initial material surface roughness and is characterized by an average roughness (Ra) value of less than or equal to 1.0 micrometers and a maximum roughness (Rz) value of less than or equal to 5.0 micrometers.

2. The method of claim 1 wherein the lithium metal material is repeatedly introduced to the first rolling mill unit in a one-way mechanical direction via multiple passes.

3. The method of claim 1 wherein the lithium metal material is introduced to the first rolling mill unit and the at least second rolling mill unit of the rolling mill system in a single mechanical direction via a single pass.

4. The method of claim 3 wherein the lithium metal material is introduced to the rolling mill system without folding the lithium metal material and/or without introducing the lithium material in a bi-directional manner.

5. The method of claim 1 wherein the average roughness value and maximum roughness value exhibited by the further compressed lithium metal material are both reduced by each compression performed by the first rolling mill unit and/or the second rolling mill unit.

6. The method of claim 1 wherein the first rolling mill unit and/or the second rolling mill unit is a tandem rolling mill device.

7. The method of claim 1 wherein the lithium metal material is a lithium metal workpiece and/or at least a portion of lithium metal foil.

8. The method of claim 1 wherein the further compressed lithium metal material exhibits a reduction in the number of grains, as compared to the lithium metal material and compressed lithium metal material, after being compressed by one or more of the first rolling mill unit and the second rolling mill unit.

9. The method of claim 1 wherein the first rolling mill unit and the second rolling mill unit are positioned in series and configured with incrementally decreasing rolling gap sizes such that the lithium metal material is incrementally compressed by the rolling mill system.

10. The method of claim 9 wherein the compression rate applied to the lithium metal material is controlled by incrementally decreasing the rolling gap spaces associated with working roller components of the first rolling mill unit and/or the second rolling mill unit.

11. The method of claim 10 wherein a rolling gap space formed by the positioning of an upper roller component and a lower working roller component of the first rolling mill unit and/or the at least second rolling mill unit is adjusted to incrementally control the compression rate applied to the lithium metal material.

12. The method of claim 1 wherein the further compressed lithium metal material is used to manufacture a lithium metal anode.

13. The method of claim 12 wherein the lithium metal anode is compatible with a lithium-ion battery, a lithium sulfur battery, a lithium air battery, or a solid-state battery.

14. A method for controlling the compression rate of lithium metal material comprising:
introducing a lithium metal material having an initial material thickness and initial material surface roughness into a first rolling mill unit of a rolling mill system;
compressing, by the first rolling mill unit, the lithium metal material into a compressed lithium metal material having a first compressed material thickness and first compressed material surface roughness;
introducing the compressed lithium metal material into either i) the first rolling mill again or ii) at least a second rolling mill unit of the rolling mill system that is positioned in series with the first rolling mill unit; and
compressing, by the first rolling mill unit or the at least second rolling mill unit, the compressed lithium metal material one or more additional times into a further compressed lithium metal material having a final compressed material thickness and a final material surface roughness, wherein the final compressed material thickness having a value at or between 5 micrometers and 200 micrometers and is less than the initial compressed material thickness and wherein the final material surface roughness is smoother than the initial material surface roughness and is characterized by an average roughness (Ra) value of less than or equal to 1.0 micrometers and a maximum roughness (Rz) value of less than or equal to 5.0 micrometers.
